(19) United States
(12) Patent Application Publication
(10) Pub. No.: US 2006/0242852 A1
(43) Pub. Date: Nov. 2, 2006

(54) Construction-use plumb bob structure

(76) Inventor: Ching-Yi Lin, Changhua Hsien (TW)

Correspondence Address: RABIN & BERDO, P.C., Suite 500, 1101 14th Street, N.W., Washington, DC, 20005, US

(21) Appl. No.: 11/115,377

(22) Filed: Apr. 27, 2005

(51) Int. Cl. G01C 15/10

(52) U.S. Cl. 33/392

(57) ABSTRACT

A construction-use plumb bob structure comprised of a blunt top, pointed bottom conical body having a thread-fastened sharp tip and a cord conjoining component respectively installed at its upper and lower extremities, wherein a recessed cavity formed in the internal section of the body ensconces a filler material of similar shape, the external threads died along its lower extent of a dish-shaped attachment unit are fastened to the internal threads tapped along the upper extent of the recessed cavity, and a threaded section at the bottom end of a narrow gauge cord is fastened into the internal threads in the attachment unit. As such, since a filler material of different composition is ensconced inside the body, the present invention weighs the same as an originally solid plumb bob such that there are no differences during utilization. Furthermore, the invention herein achieves the objective of reducing production cost.

### BACKGROUND OF THE INVENTION

1) Field of the Invention

The invention herein relates to a construction-use plumb bob structure comprised of a blunt top, pointed bottom conical body, the interior section of which ensconces a filler material of different composition such that the present invention is the same weight as an originally solid plumb bob body but of lower production cost.

2) Description of the Prior Art

Conventional plumb bobs utilized at construction sites, as indicated in FIG. 1-A and FIG. 1-B, are typically comprised of a blunt top, pointed bottom conical body A1 having a thread-fastened sharp tip A2 and cord conjoining component A3 respectively installed at its upper and lower extremities, wherein the body A1 is of various weight specifications such as 4, 8, 12, 16, and 32 pounds, enabling a narrow gauge cord B at the upper extent to become pulled into a straight line when the body A1 is suspended and thus the body A1 is often a solid entity fabricated of a metal material (as shown in FIG. 1-B) to furnish the necessary drop weight. However, it has been discovered that since the body A1 is a solid entity fabricated of a metal material that entails a high production cost, manufacturers are burdened with serious cost concerns.

### SUMMARY OF THE INVENTION

In view of the said situation, the applicant of the invention herein developed the present invention and filed an application for patent rights.

The primary objective of the invention herein is to provide a construction-use plumb bob structure in which a filler material of similar shape is fitted into a recessed cavity inside a blunt top, pointed bottom conical body and then a dish-shaped attachment unit is assembled to it; a sharp tip is thread-fastened to the lower extremity of the body and a cord conjoining component is thread-fastened to its upper extremity; as such, the body ensconces a filler material of different composition, but the present invention invariably weighs the same as an originally solid plumb bob, thereby providing for normal usage and, furthermore, achieving the objective of reducing production cost.

### BRIEF DESCRIPTION OF THE DRAWINGS

FIG. 1-A is an isometric drawing of the prior art structure.

FIG. 1-B is a cross-sectional drawing of the prior art structure after assembly.

FIG. 2 is an exploded drawing of the invention herein.

FIG. 3 is an isometric drawing of the invention herein.

FIG. 4 is a cross-sectional drawing of the invention here after assembly.

FIG. 5 is an isometric drawing of an embodiment of the invention herein.

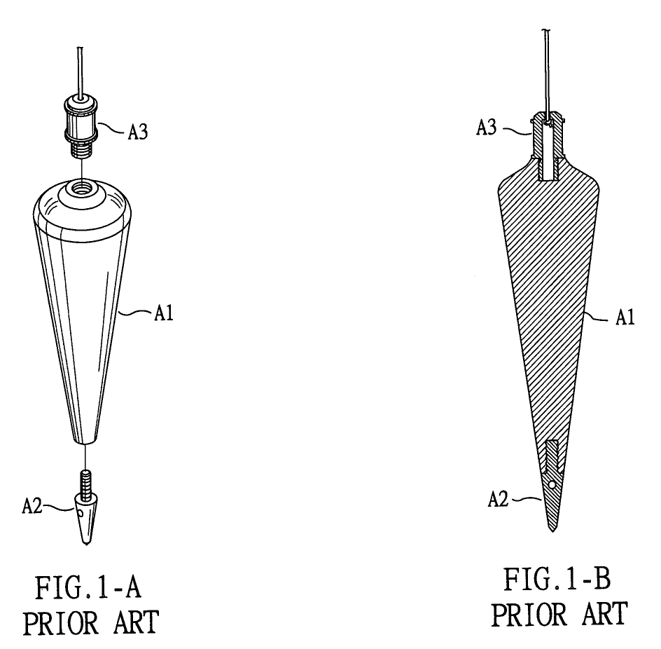

### DETAILED DESCRIPTION OF THE PREFERRED EMBODIMENT

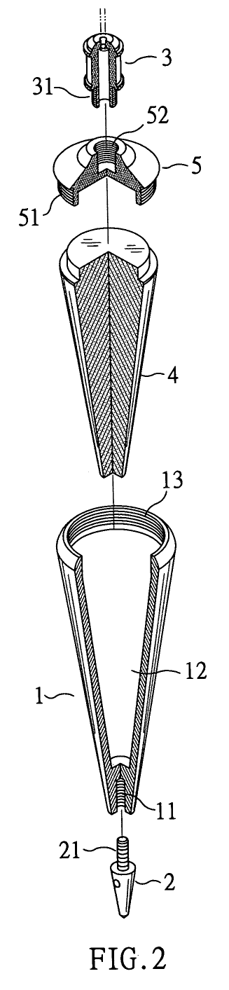

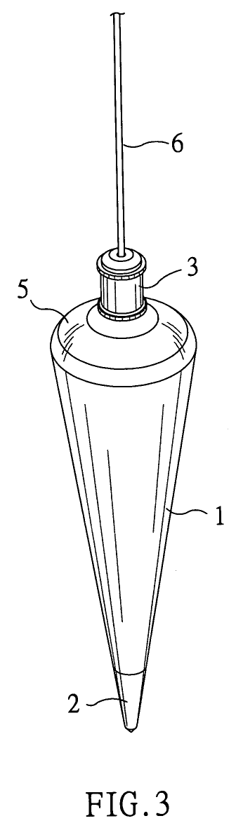

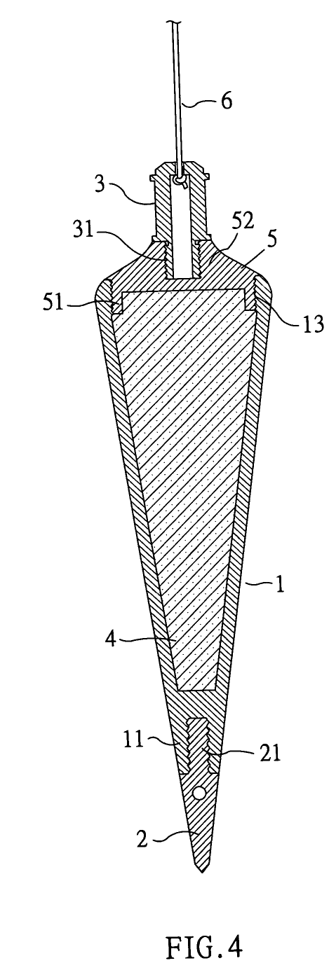

Referring to FIG. 2, FIG. 3, and FIG. 4, the construction-use plumb bob structure of the invention herein is comprised of a blunt top, pointed bottom conical body 1 having a thread-fastened sharp tip 2 and cord conjoining component 3 respectively installed at its upper and lower extremities; a threaded hole 11 tapped in the lower extremity of the main body 1 and external threads 21 died on the sharp tip 2 that are fastened therein; a recessed cavity 12 formed in the internal section of the body 1 that accommodates a filler material 4 of similar shape, and internal threads 13 tapped along the upper extent of the recessed cavity 12; the filler material 4 and the recessed cavity 12 are of identically weighted physical dimensions; an attachment unit 5 of dish shape having external threads 51 died along its lower extent and internal threads 52 tapped along the center; and a narrow gauge cord 6 connected to the attachment component 3 and, furthermore, a threaded section 31 at its bottom end fastened into the internal threads 52 in the attachment unit 5.

Therefore, the external threads 21 on the sharp tip 2 are fastened to the threaded hole 11 tapped in the lower extremity of the main body 1 and the filler material 4 is fitted into the recessed cavity 12 within the internal section of the body 1, following which the external threads 51 died along its lower extent of the attachment unit 5 are fastened to the internal threads 13 tapped along the upper extent of the recessed cavity 12; and after the attachment component 3 and the narrow gauge cord are connected, the threaded section 31 at its bottom end is fastened into the internal threads 52 in the attachment unit 5 (as shown in FIG. 3 and FIG. 4).

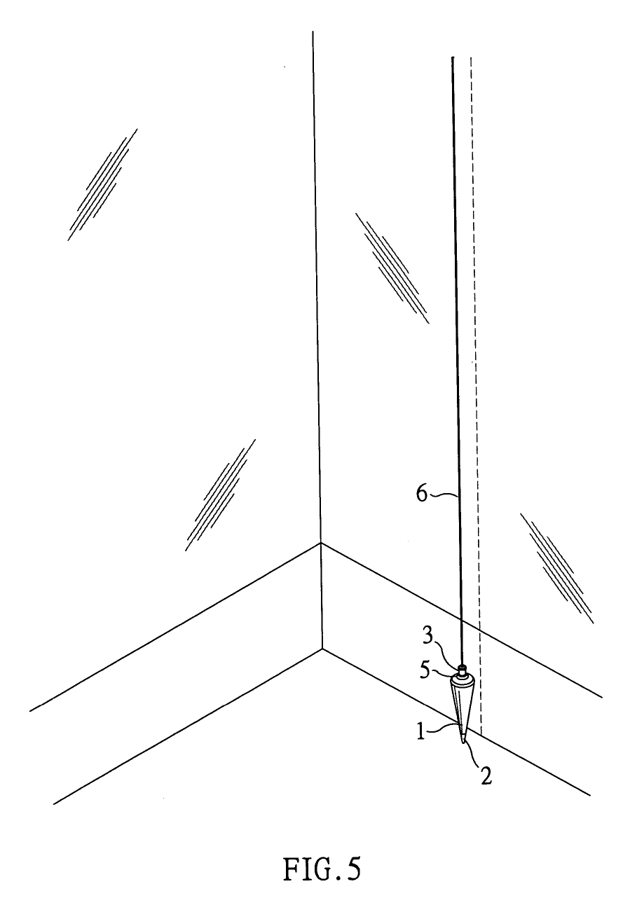

As such, since a filler material 4 of different composition is ensconced inside the body 1, the present invention weighs the same as an originally solid plumb bob such that there are no differences during utilization (as shown in FIG. 5) and the fabrication approach of the invention herein achieves the objective of reducing production cost.

In summation of the foregoing section, since the invention herein is progressive and meets the application requirements stipulated by Article 93 of the Patent Law, the present invention is submitted to the patent bureau for review and the granting of the commensurate patent rights.

1. (canceled)

2. A construction-use plumb bob structure, comprising:
a conical body having a recessed cavity formed therein, the recessed cavity being accessible through an upper opening of said conical body, said conical body having internal threads at the upper opening, and having an internally threaded hole at a bottom thereof;
a sharp tip having an externally threaded shank, and which is attachable to said conical body by engaging the threaded shank with the threaded hole;
a filler material comprised of a material that is different from a material of said conical body, and having a shape that corresponds to a shape of the recessed cavity, said filler material being removably insertable into the recessed cavity through the upper opening of said conical body;
a dish-shaped attachment unit that has external threads, said attachment unit being removably engaged with said conical body by threadably engaging the external threads of said attachment unit to the internal threads at the upper opening of said conical body, to thereby close the upper opening and retain said filler material within the recessed cavity, said attachment unit further having internal threads formed at a center thereof; and
a cord conjoining component adapted to have a cord attached thereto, and having a threaded shank at a bottom thereof, which is threadably engagable with the internal threads of said attachment unit;
wherein said attachment unit is removable from said conical body to allow the removal or insertion of the filler material, without requiring the disattachment of said cord conjoining component from said attachment unit, or said sharp tip from said conical body.

3. A construction-use plumb bob structure as recited in claim 2, wherein said filler material is solid in cross-section.
